(19) United States
(12) Patent Application Publication
(10) Pub. No.: US 2014/0280225 A1
(43) Pub. Date: Sep. 18, 2014

(54) INFORMATION MANAGEMENT SYSTEM FOR GRADING AND DISTRIBUTING INFORMATION

(71) Applicant: Sunnie SOUTHERN-BOUKERROU, Cincinnati, OH (US)

(72) Inventor: Sunnie SOUTHERN-BOUKERROU, Cincinnati, OH (US)

(21) Appl. No.: 14/218,873

(22) Filed: Mar. 18, 2014

Related U.S. Application Data
(60) Provisional application No. 61/789,537, filed on Mar. 15, 2013.

(51) Int. Cl. G06F 17/30

(52) U.S. Cl. CPC G06F 17/3053
USPC 707/748

(57) ABSTRACT

An automated program that is implemented by a data processing computer is provided with one or more Attributes that applies to each Asset to be routed for application of governance and business rules and then disseminated. An attribute can be supplied by the Innovator, a Consultant, or by the Consumer. Some Attributes are static, others are generated by the system automatically, and others are dynamic in that they depend on events that are not static.

### TECHNICAL FIELD

This invention relates to the art of information management.

### BACKGROUND OF THE INVENTION

The efficient dissemination of information presents both organizations and individuals with a wide variety of issues. For example, larger institutions, such as universities, hospitals, and corporations may maintain libraries comprising large numbers of documents that they would like to provide to consumers but are typically unable to organize economically the contents of these libraries for dissemination to persons who can use them effectively. In the present environment there is an abundance of useful information in many different fields, but it is not available in a manner that makes it as useful as it could be. A major problem with current systems is that the information is not organized, and known systems require significant resources to organize the information.

Additionally, an institution may offer services or physical articles for use or sale, including for-profit sales and charitable offerings. Efficient offering of these items presents a problem that presently is addressed in an ad hoc fashion, where each item is considered independently without taking advantage of available data indicating markets, potential consumers, and the like. Dissemination of these items more efficiently would reduce the associated costs and accordingly reduce the prices to consumers or users.

It is an object of this invention to provide a system capable of managing a large volume of informational items such that users of systems providing access to the items are presented with the item most likely to fit their needs.

### SUMMARY OF THE INVENTION

The invention relates to an information management system for distributing informational or other items that can itself be provided to an institution having a library of the informational items or to an organization offering other assets to consumers to manage their distribution. As used herein “asset” refers to a digital or physical object, such as content, information, and data that can be found in books videos, presentations, compilations of data, websites, mobile applications, events, and the like. An asset is also a service such as building a website, preparing a tax return, or a certain number of hours of babysitting. As used herein “item” refers to an asset, an Innovator's profile, or a Consumer's profile. The term “information” refers to all sorts of information, including documents, reports, brochures, books, videos, protocols, directions, and the like. The substance of the information will depend on the type and purpose of the organization. For example, an organization whose purpose is to manage personal finances may want to provide its members with information relating to the economy, banking, investments, etc. On the other hand, a hospital may want to provide its patients, doctors, and the general public with information relating to health in general and particular health issues, such as diabetes.

As used herein “Innovator” refers to the person or organization disseminating the assets, and “Consumer” refers to persons or organizations using the assets.

In accordance with the invention an automated program, which can be implemented by a data processing computer, is provided with one or more Attributes that applies to each item, which are used to determine the dissemination, routing, and availability of each item. An attribute can be supplied by the Innovator, a Consultant, or by the Consumer. Some Attributes are generated by the system automatically, and other Attributes are dynamic in that they depend on events that are not static. Examples of Attributes are:

TABLE 1

| Providing Entity → | Dynamic (Learns | System | | | |
|---|---|---|---|---|---|
| Attribute ↓ | and adapts) | Generated | Innovator | Consultant | User |
| Governance | | | X | | |
| Business Rules | | | X | | |
| Policies | | | | X | |
| Market Insights | | | | X | |
| Industry Know-how | | | | X | |
| Personal demographics | | | | | X |
| User attributes | | | | | X |
| User activity | X | | | | X |
| User activity capture | X | X | | | |
| Group/Dept./Organization/ | | | | | X |
| Community Demographics | | | | | |
| Group/Dept./Organization/ | | | | | X |
| Community Specific Aspects | | | | | |
| Group activity in system | X | X | | | |
| Asset-specific factors | | | X | | |
| Asset history | | | X | | |
| Asset activity | X | X | | | |

The attributes of Table 1 may be described as follows:
a. Governance: This attribute refers to the management and regulation of the Information System set up by a company to achieve its objectives. As such, governance forms an integral part of overall corporate governance. An example of a “rule” that may fall under “Governance” is that something to be “sold” through the information management system must first be reviewed and approved by a pricing committee. This Attribute doesn't necessarily identify the members, for example, of a pricing committee or how it needs to be reviewed, but only that it must be reviewed. Details such as these may be included in the “business rules.” Each organization will have different requirements for the governance attribute, which can be specified in each particular system of the invention.
b. Business Rules: This attribute relates to or constrains some aspect of the business. Business rules are intended to assert business structure or control or influence the behavior of the business. Business rules describe the operations, definitions and constraints that apply to an organization. Business rules can apply to people, processes, corporate behavior and computing systems in an organization, and are put in place to help the organization achieve its goals. For example Business Rules for the organization may require each item to be offered for sale to be considered by a pricing committee and who on the pricing committee is responsible for reviewing the items/assets that will be sold and how they will be reviewed.
c. Policies: This attribute relates to a course or principle of action adopted or proposed by a government, party, business, or individual. This attribute is typically determined by an entity outside of the organization, such as a federal, state, or other influential body that has instituted specific policies to be followed. For example—HIPAA (Health Insurance Portability and Accountability Act) defines what “private health information” is and how it can be shared. The system of the invention will ensure compliance with such policies.
d. Market Insights: This attribute is provided by the consultant and relates to insight that the consultant might have that is specific to the particular asset about the market that will influence the success of an item/asset. For example, if an innovator is creating a new personal training business and it is a trend to offer some classes outdoors, the system will provide that information. The information is automatically provided based on attributes about the innovator and the asset, thus generally obviating the need for a high-priced business consultant.
e. Industry Know-how: This attribute is provided by the consultant and relates to information known by the particular industry with regard to understanding “how” consumers seeking specific types of information want to receive it. This is provided via tips and best practices that are a core component of the that helps improve the successful dissemination and consumption of the assets.
f. Personal demographics: This attribute will be such things specific to a user as age, gender, family status, geographic location, income, etc.
g. User attributes: This attribute relates to generally fixed but also variable information about the user that go beyond demographics, such the High School or College, the role in an organization, religious, food, and music preferences, and health.
h. User activity: This relates to the history of the user's activity in the system.
i. User activity capture: This attribute relates to the activities of the Consumer.
j. Group/Dept./Organization/Community Demographics: This attribute relates to the average demographics of a group.
k. Group/Dept./Organization/Community Specific Aspects: This attribute relates to factors that go beyond demographics, such as favorite meeting places and the types of information to which they are attracted (e.g., videos, books, health issues).
l. Group activity in system: This attribute relates to the activity of a group in the system.
m. Asset-specific factors: This attribute identifies the type of asset (e.g., video, book, presentation) and the category of asset (e.g., diabetes, cancer, ADHD).
n. Asset history: This attribute relates to the history of the asset outside of the system but may include such factors as who posted the asset and when and where.
o. Asset activity: This attribute relates to the history of the asset in the system.

Each Item in the information management system of the invention is independent of the other Items, and each is provided with one or more attributes such as those exemplified above. One objective is to allow an organization to standardize the dissemination of assets to facilitate the entry of new products and services into the market. This mitigates risk and reduces transaction costs for managing the documentation associated with the assets and in obtaining the necessary approvals from reviewers. This ensures that each asset has the required documentation and has been subjected to the necessary reviews.

In an embodiment, the Innovator builds its own profile (e.g., Item). When building this profile, the system of the invention will interrogate the Innovator to obtain information that identifies the Innovator and allows assessment of its experience, expertise, and know-how. The system is capable of assigning a set of values to that Innovator based on such key factors.

The Innovator may also build a profile for each Asset. The system of the invention also provides a set of questions to interrogate the Innovator about the asset to capture the relevant information. This information can be used to identify many things, such as target consumers. By way of example, an institution with a large number of documents might use a Builder to review each document and to create the Asset based upon the questions provided by the information system by way of an electronic template, and this information is recorded by the system, and one or more appropriate Attributes generated.

The Consumer will also be asked to build a profile Item. The system will ask the consumer for information to identify the Consumer's needs so that the system can push particular products and/or services. The system of the invention will also assign attributes to the Consumer that can be used to assign a value to the Consumer's characteristics. For example, the system considers a Consumer's expression of something “liked” to be an active contribution. The system also detects when the Consumer views an asset and the period of time the Consumer views an asset, and considers them passive responses to the offered assets.

While each item might require a manual input of certain initial Attribute information, the advantage of the system is that the rules are automatically applied. As discussed above, the Attribute can include (1) the type of item (e.g., report, peer reviewed article, brochure, etc.), the person who provided the item (e.g., the director, a physician, a researcher, etc.) the intended use of the item, the characteristics of the person using the system to retrieve the items (e.g., a physician, a patient, a legal reviewer, etc.), and other factors which may be relevant in identifying the persons to whom the item should be made available. In addition, factors such as the number of times the item is accessed or external reviews regarding effectiveness in other programs can be used to adjust the dissemination in real time.

An example of a process for implementing the invention is as follows:
a. An item (e.g., profile/asset) is uploaded into the system and the person initiating the upload fills out a template that provides basic information about the document, as noted above;
b. The system applies a set of Governance and Business rules to the document based on the information provided in the template and the information obtained from the Innovator;
c. The system routes assets requiring prior approvals, such as medical or legal approvals, to the appropriate persons for approval;
d. The system then forwards identification of the Assets, the Assets themselves, or web-based links to the Assets to the appropriate dissemination channel, such as a hospital website.

The application of the Attributes to the several Items is an important feature of the invention. This is preferably accomplished with the use of an algorithm that converts each Attribute to a coefficient, or ranking, for each Item based on the internal information obtained from the template or external information obtained from social websites or the like that provide information regarding the effectiveness or popularity of the particular Item. The system is capable of using information obtained from the template to route the item for review or authorization, and also applies the predetermined rules to generate a ranking of the items importance and determine the webpages or other displays on which the item will be made available to the users.

### BRIEF DESCRIPTION OF THE DRAWING FIGURES

FIG. 1 is a schematic of the various conceptual elements of an information management system of the invention.

FIG. 2 is a schematic of the physical elements of an information management system of the invention.

### DETAILED DESCRIPTION OF PREFERRED EMBODIMENTS

FIG. 1 illustrates the major features of an embodiment of the information management system according to the invention. The major elements shows are the Innovators 2, the Assets 4, and the Consumers 6. As indicated, in general the Innovators create the Assets, and the Consumers use (consume) the Assets. To implement the management system, the Innovators generate Innovator Profiles 8, and Asset profiles 10. The Consumers generate Consumer Profiles 12. The information management system receives all of the profiles as well as the Attributes to ties Items together in an efficient system for dissemination of the Assets.

FIG. 2 illustrates a hardware connection showing the Innovator connected to the information management system, and the information management system connected to the Consumer and optionally to the Internet. The Consumer is also optionally connected to the Internet in those instances where the Assets are disseminated to the Consumers via the Internet.

An initial example for application of the invention is taken from the field of health care in general, and a patient with diabetes in particular.

It is generally accepted that health care is moving from a payment model defined by the “episodes of care” to one that is based on the quality of the outcomes. Quality health outcomes are impacted by myriad factors, including:
a. Diagnosis
b. Treatments prescribed by the health provider,
c. Care plans developed by the care provider, and
d. Patients understanding of their care plans and adherence to/compliance with recommendations/orders of their provider.
   The patient needs to be educated on “what to do” and “how to do it” and then the patients need to do “what” they are supposed to do in the “way” that they are supposed to do it.

Thus, an objective of the invention is to standardize the available materials and reduce redundancy for providers and patients. Currently, there is essentially no standard method of determining what types of educational materials are most effective in educating patients and getting them to implement new behaviors or change old behaviors. This results in a lack of standardization and a duplication of creation, purchase, and distribution of materials that advise providers how to educate patients as well as to educate patients how to care for themselves. The lack of standardization of materials has led to health care providers, even those within the same practice, providing patients with many different kinds of materials, while themselves being unaware of which are the best.

A person with diabetes requires care from multiple providers each of which provides a different kind of information. Even basic terms that describe the malady are often different and confusing to patients. For example, blood glucose, blood sugar, and/or A1C are all used to describe the physiological aspect measured to determine whether the patient has diabetes and how well the patient is responding to the prescribed treatments. It is also confusing for health care providers because the providers of this one patient don't know what any of the other providers are providing to educate the patient. It is challenging for the institution because the people responsible for improving outcomes for the population have a difficult time determining which “method” is best to improve outcomes the most.

The invention provides consistency in the quality of the way the educational materials appear to the patient. It has been found that a challenge to health care providers and other institutions when providing educational materials is how the materials look, the consistency of the patient's understanding of the content, and the patient's identification of the source of the products. Moreover, the legal, regulatory, an individual to “self-publish” and distribute content to large numbers of people very quickly and easily, which creates liability for institutions in the areas of legal, regulatory compliance, medical, and consumer recognition.

Application of the proposed system by a health care provider ensures that each informational item will have an appropriate initial score that can change over time based on who uses it, how it is used, how often it is used, and the value of the experience the user has with the content/item. Thus, for example an Asset will have several Attributes that require it to be treated in certain ways, such as being reviewed by pricing administrators and also being documented by regulatory administrators. At the same time, an Asset can be associated with a composite Attribute score in those instances where several Attributes are taken into account to provide a single composite Attribute determined from weighted calculations of individual Attributes. For example, User Attributes, User Activity, and User Activity Capture can be combined to provide a single score by applying coefficients to each and making a calculation to a User's affinity for the particular asset and, hence, the importance of that Asset to a User. The particular calculation may change for each Asset or Asset class and can be a simple summation of weighted factors or can be a more complicated and non-linear calculation.

Finally, individual employees often have very difficult and time-consuming experiences navigating the “system” to ensure that the appropriate people have “reviewed” and “approved” the information items that are being distributed throughout the institution/organization and the public. The system proposed addresses each of these factors by routing the Items to the appropriate places before making them available.

A second example is directed to assisting businesses to provide an appropriate Quality Rating and the “Best Fit” when connecting startup companies, service providers, and investors based on matching abilities, needs, capabilities, investment criteria, and startup company growth potential. Currently, the process followed by startup companies to access needed resources to help build their companies is very difficult and time consuming. It is also difficult for service providers (like software developers, graphic designers, accountants, attorneys, etc.), to identify potential new customers. Another group that is interested in identifying potential startup companies is investors. Investors spend their time searching for new companies to invest in, evaluating potential investment opportunities, helping companies identify resources, and then making sure the companies are doing “what they are supposed to do”. The proposed system of the invention will provide a directory of startup companies, service providers, and investors looking to invest. Each entity will have a profile and will complete a questionnaire/intake document. The system will, then apply its rules to automatically match startup companies, service providers, and investors based on a “best fit” and will make recommendations for companies based on what each stake holder has to provide and is seeking to obtain.

The “quality rating” system proposed by the invention will also be used to facilitate identification of the highest quality startup companies, service providers, and even investors based on specific criteria and user/customer feedback.

In summary, and example of an information management system process is as follows:
a. An Innovator identifies Assets to be disseminated;
b. The Innovator optionally confers with a Consultant to identify and develop the several Attributes;
c. The consultant configures a program, preferably software capable of running on any known electronic computer but, optionally, a manual system.
d. A Builder reviews each Asset and provides the appropriate Attributes to relating to each Asset. In this step the Builder is guided by a questionnaire provided by the Consultant or Innovator.
e. The information provided by the Builder in step (d) is provided to the computer or other manifestation of the program to generate an Asset Profile. In this step the Asset Profile includes both uncalculated mandatory features, such as a requirement for pricing approval, and one or more calculated Attributes. The calculated Attributes result from the application of an algorithm to the various Attributes of concern. The Attributes, including the calculated Attributes may be static or flexible depending on the individual Attributes considered.
f. A User provides information to the program, preferably guided by a questionnaire, and this information is provided to the program to develop a presentation of Assets to the User based on the User Profile and the Asset Profile. As noted some aspects will be static and others will be dynamic. Thus, the User may be presented with additional Assets depending on the activity of the User in response to the original presentation. As well, the algorithm can change depending on updates or changing Attributes including Market Insights, Business Rules, etc.

Modifications within the scope of the appended claims will be apparent to those of skill in the art.

I claim:

1. A process for disseminating assets comprising the steps of assigning to each of said assets a plurality of attributes and disseminating said assets in accordance with said attributes.

2. A process according to claim 1 further comprising dissemination said assets in accordance with a consumer profile.

3. A process according to claim 2 further comprising disseminating said assets according to fixed attributes and dynamic attributes.

4. A process according to claim 3 further comprising disseminating said assets wherein a plurality of said attributes are assigned numerical values and are combined to provide a single calculated attribute.

5. A process according to claim 4 wherein each of said plurality of numerical values is modified by a coefficient.

6. A process according to claim 5 wherein at least one of said coefficients differs from the remainder of the coefficients.

7. A process according to claim 1 wherein at least one of said attributes is assigned to an asset based on an Innovator profile.

8. A process according to claim 1 wherein at least one of said attributes is assigned based on a Consumer profile.

9. A process according to claim 1 wherein at least one of said assets is a document.

10. A process according to clam 1 wherein at least one of said assets is a service.

11. A process according to claim 1 wherein at least one of said assets is an article.
